(19) United States
(12) Patent Application Publication
(10) Pub. No.: US 2016/0350545 A1
(43) Pub. Date: Dec. 1, 2016

(54) TRANS-LOCALITY BASED FIXED STORAGE SECURITY

(71) Applicant: Lenovo Enterprise solutions (singapore) PTE. LTD., New Tech Park (SG)

(72) Inventors: Gary D. Cudak, Wake Forest, NC (US); Christopher J. Hardee, Raleigh, NC (US); Adam Roberts, Moncure, NC (US)

(21) Appl. No.: 14/723,418

(22) Filed: May 27, 2015

(51) Int. Cl. G06F 21/62; H04L 9/08; H04L 9/32

(52) U.S. Cl. CPC G06F 21/62; H04L 9/3231; H04L 9/088

(57) ABSTRACT

Embodiments of the present invention provide a method, system and computer program product for trans-locality based fixed storage security. In an embodiment of the invention, a method for trans-locality based fixed storage security includes storing in memory of a fixed disk a key received from a key source over a computer communications network. The method also includes receiving in firmware of the fixed disk from a physically coupled computer by way of a drive interface cable a request to access encrypted data stored in the fixed disk and, in response, retrieving the key received from the key source and determining a validity of the retrieved key. Finally, the method includes decrypting the encrypted data and returning the decrypted data to the computer if the retrieved key is valid, but otherwise denying the request.

### BACKGROUND OF THE INVENTION

Field of the Invention

The present invention relates to fixed storage security and more particularly to data encryption in fixed storage.

Description of the Related Art

In the beginning, commercial utilization of computing systems as a tool of business or government had been based solely upon large, centralized computing facilities in which one or more computers with attached storage processed computing operations as directed by end users through coupled terminals with the results of the computing reported to the coupled terminals. Data created and managed within the centralized computing system remained within the enterprise computing system in large storage arrays. The advent of personal computing and client server computing, however, resulted in a shift of data away from the centralized storage arrays and towards the local fixed disks of the personal computers participating in a computer network. The further development of mobile computing and the exponential decline in the cost of fixed storage only further expanded the widespread utilization of large disk storage within individual computers.

With the widespread utilization of large disk storage in computing devices, however, arises a new challenge in the form of data security. Previously, with centralized storage of data, securing centrally stored data amounted to little more than securing the location at which the central data had been located. Further access controls could be implemented so as to limit access to the underlying centrally stored data. To the extent that data is stored locally in a personal computing device, though, more sophisticated methods of securing data are required. To that end, it has become commonplace to secure local disks using encryption technology dependent upon privately known encryption keys, or in extreme cases, upon biometric inputs. In both instances, the security of a fixed disk depends upon logic and circuitry present in the computer itself.

Yet, it no longer is unusual for one to physically remove a fixed disk from a computer to a different locale at which locale the disk can be accessed through another computer or fixture. Indeed, the modern commercial market presently offers for sale fixtures for converting a fixed disk to portable storage through the removal of the fixed disk from a computer and placement of the fixed disk into the fixture. Thus, security measures dependent upon a particular computer in a particular location are not necessarily sufficient to ensure the security of data on a fixed disk in so far as one can simply remove the fixed disk to a different location unprotected by the logic and circuitry of the computer from which the fixed disk had been removed.

### BRIEF SUMMARY OF THE INVENTION

Embodiments of the present invention address deficiencies of the art in respect to securing a fixed disk and provide a novel and non-obvious method, system and computer program product for trans-locality based fixed storage security. In an embodiment of the invention, a method for trans-locality based fixed storage security includes storing in memory of a fixed disk a key received from a key source over a computer communications network. The method also includes receiving in firmware of the fixed disk from a physically coupled computer by way of a drive interface cable a request to access encrypted data stored in the fixed disk and, in response, retrieving the key received from the key source and determining a validity of the retrieved key. Finally, the method includes decrypting the encrypted data and returning the decrypted data to the computer if the retrieved key is valid, but otherwise denying the request.

In one aspect of the embodiment, the key expires after a threshold period of time has elapsed necessitating a receipt of a new key from the key source in order to decrypt the encrypted data. In another aspect of the embodiment, the key is received from the key source in response to the request to access the encrypted data by the physically coupled computer. Finally, in yet another aspect of the embodiment, the data stored in the fixed disk both is encrypted in a manner able to be decrypted by the key from the key source, and also is encrypted in a manner able to be decrypted by a second key present in the fixed disk.

In another embodiment of the invention, a data processing system is configured for trans-locality based fixed storage security. The system includes a fixed disk. The fixed disk includes each of a physical storage medium, a read/write mechanism adapted to read and write data to and from the physical storage medium, both memory and also a processor disposed on the fixed disk, and a cable connector configured to receive a device interface cable coupling the fixed disk to a computer. The system also includes a security module stored in firmware also disposed on the disk. The module includes program code enabled upon execution by the processor of the fixed to store in the memory of the fixed disk a key received from a key source from over a computer communications network, to receive from the computer by way of a drive interface cable a request to access encrypted data stored in the fixed disk, to retrieve the key received from the key source and determine a validity of the retrieved key and to decrypt the encrypted data and return the decrypted data to the computer if the retrieved key is valid, but otherwise to deny the request.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for trans-locality based fixed storage security;

FIG. 2 is a schematic illustration of a data processing system configured for trans-locality based fixed storage security; and,

FIG. 3 is a flow chart illustrating a process for trans-locality based fixed storage security.

### DETAILED DESCRIPTION OF THE INVENTION

Embodiments of the invention provide for trans-locality based fixed storage security. In accordance with an embodiment of the invention, an access request to access data stored in a fixed disk is received within the fixed disk. Security logic disposed within the fixed disk retrieves a key received from over a data communications network in order to decrypt the data. Optionally, the received key expires after a lapse of time necessitating a periodic refreshing of the received key. To the extent that the key is not valid or not accessible by the fixed disk, then the fixed disk denies the access request. Otherwise, access to the requested data is permitted and optionally, additionally decrypted utilizing a locally provided key. In this way, the fixed disk is secured from afar irrespective of the location of the fixed disk and whether or not the fixed disk remains in any particular computer or fixture.

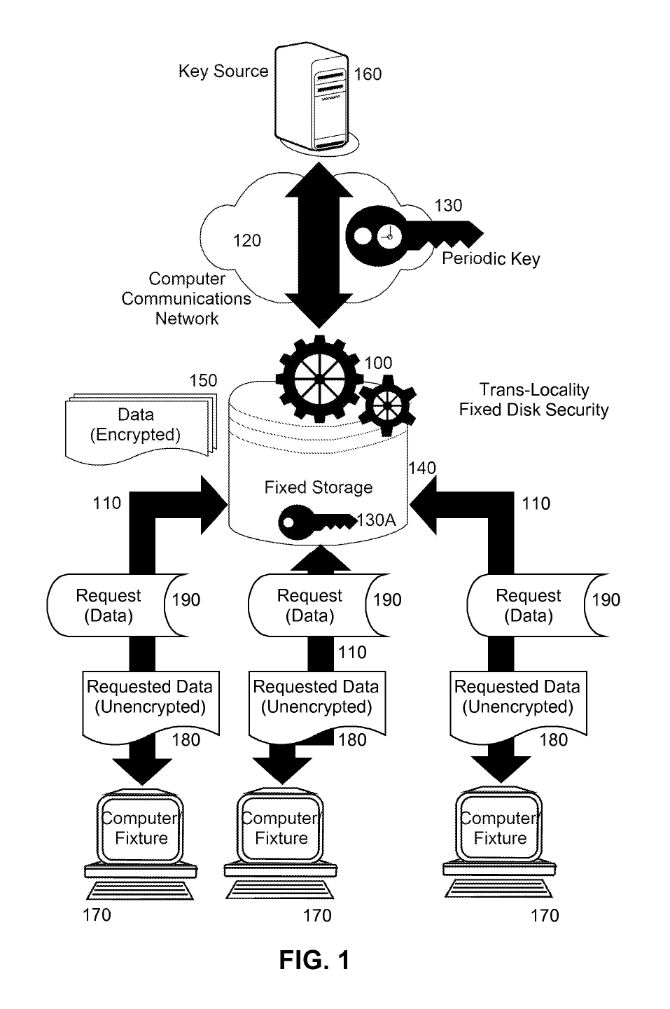

In further illustration, FIG. 1 pictorially shows a process for trans-locality based fixed storage security. As shown in FIG. 1, a fixed disk 140 such as a hard disk drive or solid state disk drive receives a key 130 from a key source 160 from over a computer communications network 120, for instance the global Internet. The key source 160 may be a server providing a service through which one or more keys are provided periodically to requestors whether on demand by each requestor, or on schedule as determined by the key source 160. Optionally, each key 130 can include an expiration value subsequent to which date or time (or both) the key 130 no longer is valid. Subsequently, trans-locality fixed disk security logic 100 encrypts data 150 stored within the fixed storage 140.

Thereafter, trans-locality fixed disk security logic 100 receives a request 190 to access the data 150. In this regard, the request can be a read or a write request and can issue from a computer 170 to which the fixed storage 140 is coupled by way of a physical linkage 110 such as a device interface cable. Optionally, the fixed storage 140 is coupled by way of a physical linkage 110 to a fixture that in turn is coupled to a computer 170 through the use of a device interface cable. In any event, the trans-locality fixed disk security logic 100 processes the received request for the data by determining if the key 130 is still valid. If not, the request is denied. Otherwise, the key is used to decrypt the data 150 and the decrypted data 180 requested in the request is returned to the requestor over the physical linkage 110. Optionally, to the extent that data 150 is additionally encrypted using a locally generated key 130A that is local to the fixed storage 140, the data 150 can be additionally decrypted using the locally generated key 130A before returning the now decrypted data 180 to the requestor.

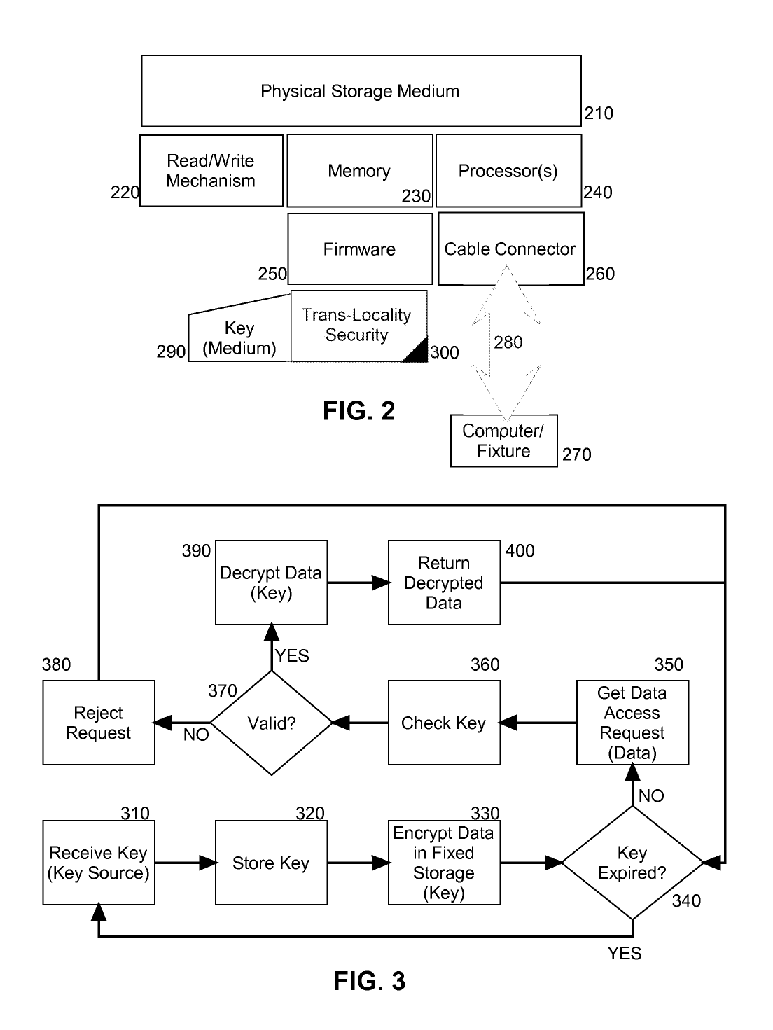

The process described in connection with FIG. 1 can be implemented in a data processing system. In yet further illustration, FIG. 2 schematically shows a data processing system configured for trans-locality based fixed storage security. The system includes a fixed disk defined by a physical storage medium 210 such as solid state memory or a collection of one or more magnetically coated platters, or a collection of one or more magneto-optical discs. The system also includes a read/write mechanism 220 adapted to read and write data to the physical storage medium 210, such as a magnetic head affixed to an actuator arm. The system yet further includes both memory 230 and one or more microprocessors 240 attached directly to the fixed disk. In this way, program code disposed in firmware 250 can execute in the memory 230 of the fixed disk by the processor(s) 240 of the fixed disk without relying upon the processing resources of a coupled computer 270. Finally, the system includes a cable connector 260 configured to receive a device interface cable 280 coupling the fixed disk to the computer 270 (or fixture as the case may be).

Of note, a trans-locality security module 300 is disposed in the firmware 250. The trans-locality security module 300 includes program code that when executed by the processor(s) 240 is enabled to process requests to access data in the physical storage medium received from the computer 270 over the device interface cable 280 by validating a key 290 present in memory 230 and then utilizing the key 290, if valid, to decrypt the requested data before returning the decrypted form of the requested data to the computer 270. Conversely, the program code is enabled to deny the request if the key 290 is determined to have expired or to be invalid. In either circumstance, the program code is even yet further enabled upon execution to periodically receive a new key 290 form a key source over a computer communications network and to decrypt the data stored in the physical storage medium 210 with the old key before re-encrypting the data stored in the physical storage medium 210 with the new key 290.

In even yet further illustration of the operation of the trans-locality security module 300, FIG. 3 is a flow chart illustrating a process for trans-locality based fixed storage security. Beginning in block 310, a key is received from a key source in the fixed storage from over a computer communications network. The key can be a key provided globally by the key source to a set of different fixed storage, or the key can be a key specifically provided by the key source to the fixed storage receiving the key. Regardless, in block 320 the key can be stored in memory of the fixed storage and in block 330, the key is used to encrypt the data in the fixed storage. Thereafter, in decision block 340 it can be determined periodically if the key has expired. If so, a new key can be received in block 310 and the process can repeat through block 320. Otherwise, the process can continue in block 350.

In block 350, a request to access data in the fixed storage can be received from over a device interface cable coupling the fixed storage to a computer (or to a computer by way of a fixture). In block 360, the key in memory of the fixed storage can be validated. In decision block 370, if the key is determined to be invalid or expired, in block 380 the request is rejected. Otherwise, in block 390 the requested data is decrypted using the key and the decrypted data is returned to the computer by way of the device interface cable in block 400. In this way, the data encrypted on the fixed storage remains secure irrespective of the locality of the fixed storage whether disposed in a different computer or in a fixture coupled to a computer.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for trans-locality based fixed storage security, the method comprising:
storing in memory of a fixed disk a key received from a key source over a computer communications network;
receiving in firmware of the fixed disk from a physically coupled computer by way of a drive interface cable a request to access encrypted data stored in the fixed disk;
retrieving the key received from the key source and determining a validity of the retrieved key; and,
decrypting the encrypted data and returning the decrypted data to the computer if the retrieved key is valid, but otherwise denying the request.

2. The method of claim 1, wherein the key expires after a threshold period of time has elapsed necessitating a receipt of a new key from the key source in order to decrypt the encrypted data.

3. The method of claim 1, wherein the key is received from the key source in response to the request to access the encrypted data by the physically coupled computer.

4. The method of claim 1, wherein the data stored in the fixed disk both is encrypted in a manner able to be decrypted by the key from the key source, and also is encrypted in a manner able to be decrypted by a second key present in the fixed disk.

5. A data processing system configured for trans-locality based fixed storage security, the system comprising:
a fixed disk comprising a physical storage medium, a read/write mechanism adapted to read and write data to and from the physical storage medium, both memory and also a processor disposed on the fixed disk, and a cable connector configured to receive a device interface cable coupling the fixed disk to a computer; and,
a security module stored in firmware also disposed on the disk, the module comprising program code enabled upon execution by the processor of the fixed to store in the memory of the fixed disk a key received from a key source from over a computer communications network, to receive from the computer by way of a drive interface cable a request to access encrypted data stored in the fixed disk, to retrieve the key received from the key source and determine a validity of the retrieved key and to decrypt the encrypted data and return the decrypted data to the computer if the retrieved key is valid, but otherwise to deny the request.

6. The system of claim 5, wherein the key expires after a threshold period of time has elapsed necessitating a receipt of a new key from the key source in order to decrypt the encrypted data.

7. The system of claim 5, wherein the key is received from the key source in response to the request to access the encrypted data by the physically coupled computer.

8. The system of claim 5, wherein the data stored in the fixed disk both is encrypted in a manner able to be decrypted by the key from the key source, and also is encrypted in a manner able to be decrypted by a second key present in the fixed disk.

9. A computer program product for trans-locality based fixed storage security, the computer program product comprising a computer readable storage medium having program instructions embodied therewith, the program instructions executable by a device to cause the device to perform a method comprising:
storing in memory of a fixed disk a key received from a key source over a computer communications network;
receiving in firmware of the fixed disk from a physically coupled computer by way of a drive interface cable a request to access encrypted data stored in the fixed disk;
retrieving the key received from the key source and determining a validity of the retrieved key; and,
decrypting the encrypted data and returning the decrypted data to the computer if the retrieved key is valid, but otherwise denying the request.

10. The computer program product of claim 9, wherein the key expires after a threshold period of time has elapsed necessitating a receipt of a new key from the key source in order to decrypt the encrypted data.

11. The computer program product of claim 9, wherein the key is received from the key source in response to the request to access the encrypted data by the physically coupled computer.

12. The computer program product of claim 9, wherein the data stored in the fixed disk both is encrypted in a manner able to be decrypted by the key from the key source, and also is encrypted in a manner able to be decrypted by a second key present in the fixed disk.
